(19) United States
(12) Patent Application Publication
(10) Pub. No.: US 2020/0354504 A1
(43) Pub. Date: Nov. 12, 2020

(54) POLYASPARTIC COMPOSITIONS

(71) Applicant: Covestro LLC, Pittsburgh, PA (US)

(72) Inventors: Robert A. Wade, Oakdale, PA (US); Kurt E. Best, Wexford, PA (US); Charles A. Gambino, McDonald, PA (US)

(21) Appl. No.: 16/775,349

(22) Filed: Jan. 29, 2020

Related U.S. Application Data
(60) Provisional application No. 62/843,675, filed on May 6, 2019.
(60) Provisional application No. 62/855,063, filed on May 31, 2019.
(60) Provisional application No. 62/869,600, filed on Jul. 2, 2019.

(51) Int. Cl. C08G 18/38; C08G 18/73; C08G 18/75; C08G 18/76; C09D 175/02

(52) U.S. Cl. CPC C08G 18/3821; C08G 18/735; C09D 175/02; C08G 18/7621; C08G 18/752

(57) ABSTRACT

The present invention provides a polyaspartic composition comprising a polyaspartate comprising a reaction product of a polyamine and a diester, and a C₂ to C₁₂ diol. The inventive polyaspartic compositions may be combined with polyisocyanates to produce polyurea coatings, adhesives, sealants, composites, castings, and films.

### RELATED APPLICATIONS

The present application claims the benefit of U.S. Provisional Application Ser. No. 62/869,600, filed Jul. 2, 2019, U.S. Provisional Application Ser. No. 62/855,063, filed May 31, 2019, and U.S. Provisional Application Ser. No. 62/843,675, filed May 6, 2019, each of which is incorporated herein by reference.

### FIELD OF THE INVENTION

The present invention relates in general to polyaspartic compositions including a polyaspartate and a diol. These polyaspartic compositions can be combined with polyisocyanate compositions to produce polyurea compositions and/or coatings.

### BACKGROUND OF THE INVENTION

Two-component (2K) coating systems and compositions can be used to produce a variety of polyurethanes or polyureas, which are widely used in industry because of the many advantageous properties exhibited by these coating chemistries. 2K coating systems generally include a liquid binder component and a liquid hardener/crosslinker component. The liquid binder component may include an isocyanate-reactive component, such as a polyol or polyamine, and the liquid crosslinker component may include a polyisocyanate component. The addition reaction of the polyisocyanate component with the isocyanate-reactive component produces highly crosslinked polyurea or polyurethane networks that form coating films which can be applied to substrates.

For some applications and/or reaction environments, reactivity and physical property development for 2K coating films can be a roadblock for many manufacturers. For example, some 2K coating systems react very quickly initially, but the ultimate physical properties of the coating may not develop for several hours or days. In some additional examples, 2K coating systems react quickly in warmer climates, but do not react quickly enough and/or do not develop ultimate physical properties quickly enough in colder climates. Therefore, a need continues to exist in the art for a fast curing coating, which also has fast physical property development.

### SUMMARY OF THE INVENTION

Accordingly, the present invention reduces or eliminates problems inherent in the art by providing polyaspartic compositions including a polyaspartate and a C₂ to C₁₂ diol. The polyaspartate can include a reaction product of a polyamine and a diester at a 1:1 stoichiometric ratio. The inventive polyaspartic compositions can be mixed with polyisocyanates to produce coatings, adhesives, sealants, composites, castings, or films. This 2K system can have significantly increased reactivity and physical property development compared to such materials made with polyaspartic compositions that do not include a C₂ to C₁₂ diol.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 is a plot of tensile strength in psi of sample IV-A (less isocyanate) versus time over three days;

FIG. 2 is a plot of tensile strength in psi of sample IV-B (more isocyanate) versus time over three days;

FIG. 3 illustrates elongation percent of sample IV-A (less isocyanate) versus time over three days; and

FIG. 4 depicts elongation percent of sample IV-B (more isocyanate) versus time over three days.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “polymer” encompasses prepolymers, oligomers and both homopolymers and copolymers; the prefix “poly” in this context referring to two or more. As used herein, the term “molecular weight”, when used in reference to a polymer, refers to the number average molecular weight, unless otherwise specified.

As used herein, the term “coating composition” refers to a mixture of chemical components that will cure and form a coating when applied to a substrate.

The terms “adhesive” or “adhesive composition”, refers to any substance that can adhere or bond two items together. Implicit in the definition of an “adhesive composition” or “adhesive formulation” is the concept that the composition or formulation is a combination or mixture of more than one species, component or compound, which can include adhesive monomers, oligomers, and polymers along with other materials.

A “sealant” or “sealant composition” refers to a composition which may be applied to one or more surfaces to form a protective barrier, for example to prevent ingress or egress of solid, liquid or gaseous material or alternatively to allow selective permeability through the barrier to gas and liquid. In particular, it may provide a seal between surfaces.

A “casting” or “casting composition” refers to a mixture of liquid chemical components which is usually poured into a mold containing a hollow cavity of the desired shape, and then allowed to solidify.

A “composite” or “composite composition” refers to a material made from two or more polymers, optionally containing other kinds of materials. A composite has different properties from those of the individual polymers/materials which make it up.

“Cured,” “cured composition” or “cured compound” refers to components and mixtures obtained from reactive curable original compound(s) or mixture(s) thereof which have undergone chemical and/or physical changes such that the original compound(s) or mixture(s) is(are) transformed into a solid, substantially non-flowing material. A typical curing process may involve crosslinking.

The term “curable” means that an original compound(s) or composition material(s) can be transformed into a solid, substantially non-flowing material by means of chemical reaction, crosslinking, radiation crosslinking, or the like. Thus, compositions of the invention are curable, but unless otherwise specified, the original compound(s) or composition material(s) is(are) not cured.

As used herein, the term “pot life” refers to the period of time from the initial mixture of two or more mutually reactive components of a coating system to the point at which the resulting coating composition exhibits a workable viscosity.

As used herein, the term “cure time” refers to the time to achieve Stage D (Method B) as defined in ASTM D5895-03 (2008)—Standard Test Methods for Evaluating Drying or Curing During Film Formation of Organic Coatings Using Mechanical Recorder.

As used herein, the term “polyurethane” refers to polymeric or oligomeric materials comprising urethane groups, urea groups, or both. Accordingly, as used herein, the term “polyurethane” is synonymous with the terms polyurea, polyurethane/urea, and modifications thereof. The term “polyurethane” also refers to crosslinked polymer networks in which the crosslinks comprise urethane and/or urea linkages, and/or the constituent polymer chains comprise urethane and/or urea linkages. Carbodiimide crosslinking as is known to those skilled in the art is also contemplated in the coatings of the invention.

The coating compositions described herein may comprise a two-component (2K) coating composition. As used herein, the term “two-component” refers to a coating or coating composition comprising at least two components that must be stored in separate containers because of their mutual reactivity. For instance, two-component polyurea coating systems and compositions may comprise a hardener/crosslinker component comprising an isocyanate-functional compound, and a separate binder component comprising an amino-functional compound. The two separate components are generally not mixed until shortly before application because of the limited pot life of the mixture. When the two separate components are mixed and applied as a film on a substrate, the mutually reactive compounds in the two components react to crosslink and form a cured coating film.

As used herein, the term “polyamine” refers to compounds comprising at least two free primary and/or secondary amine groups. Polyamines include polymers comprising at least two pendant and/or terminal amine groups.

As used herein, the term “polyisocyanate” refers to compounds comprising at least two un-reacted isocyanate groups. Polyisocyanates include diisocyanates and diisocyanate reaction products comprising, for example, biuret, isocyanurate, uretdione, urethane, urea, iminooxadiazine dione, oxadiazine dione, carbodiimide, acyl urea, allophanate groups, and combinations of any thereof.

The present disclosure is directed to polyaspartic compositions. More specifically, the polyaspartic compositions described herein can include a polyaspartate and a C₂ to C₁₂ diol. The C₂ to C₁₂ diol can act as an accelerant in 2K systems including the polyaspartic compositions. Thus, for example, a polyaspartic composition as described herein can react more quickly with a polyisocyanate to form a polyurea than a polyaspartic composition that does not include a C₂ to C₁₂ diol accelerant. Furthermore, the physical properties of the resulting polyurea can develop more quickly as compared to a polyurea prepared from a polyaspartic composition that does not include a C₂ to C₁₂ diol accelerant. As such, the polyaspartic compositions described herein can provide fast gel times and physical property development for applications where this is desirable, and can provide fast gel times and physical property development in cooler climates where gel times and/or physical property development may otherwise have been slower than desirable.

In further detail, the polyaspartic compositions can include a suitable polyaspartate. Generally, the polyaspartate can be a reaction product of a polyamine and a diester at approximately a 1:1 stoichiometric ratio.

The polyaspartate can be prepared with a variety of diamines, including low molecular weight diamines, high molecular weight diamines, or a combination thereof. Additionally, the diamines can have a wide range of amine functionality, repeat unit type, distribution, etc. This wide range of molecular weight, amine functionality, repeating unit type, and distribution can provide versatility in the design of new compounds or mixtures.

Suitable low molecular weight diamines have molecular weights in various embodiments of from 60 to 400, in selected embodiments of from 60 to 300. Suitable low-molecular-weight diamines can include, but are not limited to, ethylene diamine, 1,2- and 1,3-diaminopropane, 1,5-diaminopentane, 1,3-, 1,4- and 1,6-diaminohexane, 1,3-diamino-2,2-dimethyl propane, 2-methylpentamethylenediamine, isophorone diamine, 4,4′-diamino-dicyclohexyl methane, 4,4-diamino-3,3′-dimethyldicyclohexyl methane, 1,4-bis(2-amino-prop-2-yl)-cyclohexane, hydrazine, piperazine, bis(4-aminocyclohexyl)methane, and mixtures of such diamines. Representative polyaspartates prepared from these low molecular weight diamines include DESMOPHEN NH-1220, DESMOPHEN NH-1420, and DESMOPHEN NH-1520, commercially available from COVESTRO.

In some additional embodiments of the invention, a single high molecular weight polyamine may be used. Also, mixtures of high molecular weight polyamines, such as mixtures of di- and trifunctional materials and/or different molecular weight or different chemical composition materials, may be used. The term “high molecular weight” is intended to include polyamines having a molecular weight of at least about 400 in various embodiments. In selected embodiments, the polyamines have a molecular weight of from 400 to 6,000. Non-limiting examples can include polyethylene glycol bis(amine), polypropylene glycol bis(2-aminopropyl ether), the like, or a combination thereof.

In some specific examples, the polyamine can be an amine-terminated polyether. Commercially available examples of amine-terminated polyethers include, for example, the JEFFAMINE series of amine-terminated polyethers from Huntsman Corp., such as, JEFFAMINE D-230, JEFFAMINE D-400, JEFFAMINE D-2000, JEFFAMINE D-4000, JEFFAMINE T-3000 and JEFFAMINE T-5000.

As those skilled in the art are aware, polyaspartates may be produced by the reaction of a polyamine with a Michael addition receptor, i.e., an olefin substituted on one or both of the olefinic carbons with an electron withdrawing group such as cyano, keto or ester (an electrophile) in a Michael addition reaction. Examples of suitable Michael addition receptors include, but are not limited to, acrylates, and diesters such as dimethyl maleate, diethyl maleate, dibutyl maleate, dimethyl fumarate, diethyl fumarate, and dibutyl fumarate.

In some examples, the polyaspartate may include one or more polyaspartates corresponding to formula (I):

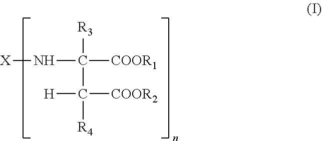

wherein:

n is an integer of at least 2;

X represents an aliphatic residue;

R₁ and R₂ independently of each other represent organic groups that are inert to isocyanate groups under reaction conditions; and

R₃ and R₄ independently of each other represent hydrogen or organic groups that are inert to isocyanate groups under reaction conditions.

In formula (I), the aliphatic residue X may correspond to a straight or branched alkyl and/or cycloalkyl residue of an n-valent polyamine that is reacted with a dialkylmaleate in a Michael addition reaction to produce a polyaspartic ester. For example, the residue X may correspond to an aliphatic residue from an n-valent polyamine including, but not limited to, ethylene diamine; 1,2-diaminopropane; 1,4-diaminobutane; 1,6-diaminohexane; 2,5-diamino-2,5-dimethylhexane; 2,2,4- and/or 2,4,4-trimethyl-1,6-diaminohexane; 1,11-diaminoundecane; 1,12-diaminododecane; 1-amino-3,3,5-trimethyl-5-amino-methylcyclohexane; 2,4′- and/or 4,4′-diaminodicyclohexylmethane; 3,3′-dimethyl-4,4′-diaminodicyclohexylmethane; 2,4,4′-triamino-5-methyldicyclohexylmethane; polyether polyamines with aliphatically bound primary amino groups and having a number average molecular weight (Mn) of 148 to 6000 g/mol; isomers of any thereof, the like, or combinations of any thereof.

In various embodiments, the residue X may be obtained from 1,4-diaminobutane; 1,6-diaminohexane; 2,2,4- and/or 2,4,4-trimethyl-1,6-diaminohexane; 1-amino-3,3,5-trimethyl-5-aminomethylcyclohexane; 4,4′-diaminodicyclohexylmethane; 3,3′-dimethyl-4,4′-diaminodicyclohexylmethane; or 1,5-diamine-2-methyl-pentane.

The phrase “inert to isocyanate groups under reaction conditions,” which is used to define groups R¹ to R⁴ in formula (I), means that these groups do not have Zerevitinov-active hydrogens. Zerevitinov-active hydrogen is defined in Rompp's Chemical Dictionary (Rommp Chemie Lexikon), 10^{th} ed., Georg Thieme Verlag Stuttgart, 1996. Generally, groups with Zerevitinov-active hydrogen are understood in the art to mean hydroxyl (OH), amino (NHₓ), and thiol (SH) groups. In various embodiments, R¹ to R⁴, independently of one another, are C₁ to C₁₀ alkyl residues, such as, for example, methyl, ethyl, or butyl residues.

In various embodiments, the polyaspartate comprises one or more compounds corresponding to formula (I) in which n is an integer from 2 to 6, in some embodiments from 2 to 4, and in some embodiments 2. In embodiments, where n=2, the polyaspartate may comprise one or more compounds corresponding to formula (I):

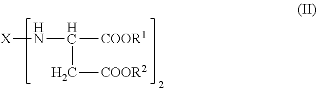

The polyaspartate may be produced by reacting the corresponding primary polyamines of the formula:

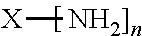

with a diester of the formula:

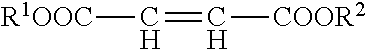

The production of the polyaspartate from the above-mentioned polyamine and diester starting materials may take place within a temperature range of 0° C. to 100° C., in certain embodiments, the temperature is no greater than 45° C.

As previously described, in addition to the polyaspartate, the polyaspartic composition can further include a C₂ to C₁₂ diol, which can act as an accelerant to accelerate a reaction between the polyaspartate and a polyisocyanate. A variety of C₂ to C₁₂ diols can be included in the polyaspartic composition. Some non-limiting examples can include ethylene glycol, 1,2-propanediol, 1,3-propanediol, 1,2-butanediol, 1,3-butanediol, 1,4-butanediol, 1,2-hexanediol, 1,5-hexanediol, 2,5-hexanediol, 1,6-hexanediol, 1,8-octanediol, 1,10-decanediol, 1,12-dodecanediol, diethylene glycol, triethylene glycol, diproplylene glycol, triproplylene glycol, the like, or a combination thereof.

In some specific examples, the C₂ to C₁₂ diol can be or include a C₂ to C₆ diol. Where this is the case, the C₂ to C₆ diol can include ethylene glycol, 1,2-propanediol, 1,3-propanediol, 1,2-butanediol, 1,3-butanediol, 1,4-butanediol, 1,2-hexanediol, 1,5-hexanediol, 2,5-hexanediol, 1,6-hexanediol, the like, or a combination thereof.

The C₂ to C₁₂ diol can be included in the polyaspartic composition in a variety of amounts. In some examples, the C₂ to C₁₂ diol can be included in the polyaspartic composition in an amount of from about 0.5 wt % to about 20 wt % based on a total weight of the polyaspartic composition. Generally, the C₂ to C₁₂ diol can be present in the polyaspartic composition in an amount of from about 1 wt % to about 10 wt % based on a total weight of the polyaspartic composition. In some additional examples, the C₂ to C₁₂ diol can be present in the polyaspartic composition in an amount of from about 0.5 wt % to about 4 wt %, from about 2 wt % to about 4 wt %, from about 1 wt % to about 5 wt %, from about 2 wt % to about 6 wt %, from about 4 wt % to about 8 wt %, or from about 6 wt % to about 12 wt % based on a total weight of the polyaspartic composition.

In some examples, the polyaspartic composition can include water. In some cases, water can also act as an accelerant. In other examples, it may be desirable to minimize the amount of water in the polyaspartic composition. Generally, the polyaspartic composition can include less than or equal to 5 wt % water based on a total weight of the polyaspartic composition. In some examples, water can be present in the polyaspartic composition in an amount of from 0.1 wt % or 0.5 wt % to about 5 wt % based on a total weight of the polyaspartic composition. In some further examples, the polyaspartic composition can include less than or equal to 3 wt % or 2 wt % water based on a total weight of the polyaspartic composition. In selected embodiments, the only water present is residual water resulting from the synthesis of the C₂ to C₁₂ diol or water present due to the hygroscopic nature of the diol.

In some examples, the polyaspartic composition can include an organic tin compound, or other suitable catalyst/accelerant (e.g. a lewis-acid, for example). Surprisingly, in some cases, organic tin compounds, or other suitable catalyst/accelerant, can accelerate development of physical properties. Thus, where development of physical properties of a polyurea composition is slower than desired, a suitable amount of organic tin compound, or other suitable catalyst/accelerant, can be included in the polyaspartic composition, for example. Where this is the case, the organic tin compound, or other suitable catalyst/accelerant, can generally be included in the polyaspartic composition in an amount of from about 0.1 wt % to about 1 wt % based on a total weight of the polyaspartic composition. In other examples, the organic tin compound, or other suitable catalyst/accelerant, can be included in the polyaspartic composition in an amount of from about 0.1 wt % to about 0.3 wt %, from about 0.2 wt % to about 0.4 wt %, or from about 0.3 wt % to about 0.5 wt % based on a total weight of the polyaspartic composition.

A variety of organic tin compounds can be included in the polyaspartic composition. Non-limiting examples can include dimethyltin diacetate, diethyltin diacetate, dibutyltin diacetate, dioctyltin diacetate, dilauryltin diacetate, dibutyltin dilaurate, dibutyltin maleate, the like, or a combination thereof.

Other suitable catalysts/accelerants can include a variety of lewis acids, for example. Non-limiting examples can include tertiary amines, sulfonic acids (e.g., dodecylbenzenesulfonic acid, paratoluene sulfonic acid, for example), other acids, the like, or a combination thereof.

A variety of additives can also be included in the polyaspartic composition. Non-limiting examples of additives can include a filler, a pigment, a catalyst, a softener, a high-boiling liquid, a UV stabilizer, an anti-oxidant, a microbiocide, an algicide, a dehydrator, a thixotropic agent, a wetting agent, a flow enhancer, a matting agent, an anti-slip agent, an aerator, an extender, the like, or combinations thereof. Additives can be included in the polyaspartic composition in an amount of from about 0.1 wt % to about 20 wt % based on a total weight of the polyaspartic composition. In some specific examples, one or more additives can be individually or collectively included in the polyaspartic composition in an amount of from about 0.1 wt % to about 4 wt %, 1 wt % to about 6 wt %, 4 wt % to about 10 wt %, about 5 wt % to about 15 wt %, or about 10 wt % to about 20 wt % based on a total weight of the polyaspartic composition.

The polyaspartic composition can have a variety of viscosities, depending on the intended application. For example, in some cases, the polyaspartic composition can have a viscosity that allows the composition to be sprayable. In other examples, the polyaspartic composition may have a viscosity that is not sprayable. In some examples, the polyaspartic composition can have a viscosity of from about 100 centipoise (cP) to about 5000 cP. In other examples, the polyaspartic composition can have a viscosity of from about 100 cP to about 2000 cP, from about 1000 cP to about 3000 cP, from about 2000 cP to about 4000 cP, or from about 3000 cP to about 5000 cP.

In some examples, the polyaspartic composition can include a diluent, such as a solvent or residual unreacted monomer, for example. In other examples, the polyaspartic composition may not include, or may include minimal, diluent. Generally, the polyaspartic composition can include from about 50 wt % to about 100 wt % solids based on a total weight of the polyaspartic composition. In some specific examples, the polyaspartic composition can include from about 50 wt % to about 70 wt %, from about 60 wt % to about 80 wt %, from about 70 wt % to about 90 wt %, or from about 80 wt % to about 100 wt % solids based on a total weight of the polyaspartic composition.

In some examples, the polyaspartic compositions disclosed herein can be included in a 2K system, such as a coating system. For example, a polyaspartic composition as described herein can be included in a 2K system with a polyisocyanate composition including a polyisocyanate. The polyaspartic composition and the polyisocyanate composition can be contained in separate containers, but can be sold or packaged together as a 2K system.

A variety of polyisocyanate compositions can be included in the 2K system with the polyaspartic composition. For example, polyisocyanates useful in the present invention may comprise any organic polyisocyanate having aliphatically, cycloaliphatically, araliphatically, and/or aromatically bound free isocyanate groups, which are liquid at room temperature or are dispersed in a solvent or solvent mixture at room temperature. In various non-limiting embodiments, the polyisocyanate may have a viscosity of from 10-15,000 mPa s at 23° C., 10-5,0 00 mPa s at 23° C., or 50-1,000 mPa s at 23° C. In certain embodiments, the polyisocyan ate may comprise polyisocyanates or polyisocyanate mixtures having exclusively aliphatically and/or cycloaliphatically bound isocyanate groups with an (average) NCO functionality of 2.0-5.0 and a viscosity of from 10-5,000 mPa s at 23, 50-1,000 mPa s at 2 3° C., or 100-1,000 mPa s at 23° C.

In various embodiments, the polyisocyanate may comprise polyisocyanates or polyisocyanate mixtures based on one or more aliphatic or cycloaliphatic diisocyanates, such as, for example, ethylene diisocyanate; 1,4-tetramethylene diisocyanate; 1,6-hexamethylene diisocyanate (HDI); 2,2,4-trimethyl-1,6-hexamethylene diisocyanate; 1,12-dodecamethylene diisocyanate; 1-isocyanato-3-isocyanatomethyl-3,5,5-trimethyl-cyclohexane (isophorone diisocyanate or IPDI); bis-(4-isocyanatocyclohexyl)methane (H₁₂MD); cyclohexane 1,4-diisocyanate; bis-(4-isocyanato-3-methyl-cyclohexyl)methane; PDI (pentane diisocyanate-bio-based) isomers of any thereof; or combinations of any thereof. In various embodiments, the polyisocyanate component may comprise polyisocyanates or polyisocyanate mixtures based on one or more aromatic diisocyanates, such as, for example, benzene diisocyanate; toluene diisocyanate (TDI); diphenylmethane diisocyanate (MDI); isomers of any thereof; or combinations of any thereof. In various embodiments, the polyisocyanate component may comprise a triisocyanate, such as, for example, 4-isocyanatomethyl-1,8-octane diisocyanate (triisocyanatononane or TIN); isomers thereof; or derivatives thereof.

Additional polyisocyanates (including various diisocyanates) that may also be included in the polyurea compositions of the present invention may include the polyisocyanates described in U.S. Pat. Nos. 5,075,370; 5,304,400; 5,252,696; 5,750,613; and 7,205,356. Combinations of any of the above-identified polyisocyanates may also be used.

The di- and tri-isocyanates indicated may be used as such, or as derivative polyisocyanates comprising biuret, isocyanurate, uretdione, urethane, urea, iminooxadiazine dione, oxadiazine trione, carbodiimide, acyl urea, and/or allophanate groups. In various non-limiting embodiments, derivative polyisocyanates comprising biuret, isocyanurate, uretdione, urethane, iminooxadiazine dione, oxadiazine trione, carbodiimide, acyl urea, and/or allophanate groups are included in the polyurea. In various embodiments, the polyisocyanate component comprises one or more of the above-identified structural groups prepared from IPDI, HDI, H₁₂MDI, and/or cyclohexane 1,4-diisocyanate.

The polyisocyanate may be hydrophilically-modified to be water-dispersible. Hydrophilically-modified water-dispersible polyisocyanates are obtainable, for example, by covalent modification with an internal emulsifier comprising anionic, cationic, or nonionic groups.

Polyether urethane type water-dispersible polyisocyanates may be formed, for example, from a reaction between polyisocyanates and less than stoichiometric amounts of monohydric polyalkylene oxide polyether alcohols. The preparation of such hydrophilically-modified polyisocyanates is described, for example, in U.S. Pat. No. 5,252,696. Polyether allophanate type water-dispersible polyisocyanates may be formed, for example, from a reaction between a polyalkylene oxide polyether alcohol and two polyisocyanate molecules under allophanation conditions. The preparation of such hydrophilically-modified polyisocyanates is described, for example, in U.S. Pat. No. 6,426,414. The polyalkylene oxide polyether alcohol used to prepare polyether type hydrophilically-modified water-dispersible polyisocyanates may comprise, for example, polyethylene oxide residues and/or polypropylene oxide residues.

Polyisocyanates may also be covalently modified with ionic or potentially ionic internal emulsifying groups to form hydrophilically-modified water-dispersible polyisocyanates. The ionic or potentially ionic groups may be cationic or anionic. As used herein, the term “ionic or potentially ionic group” refers to a chemical group that is nonionic under certain conditions and ionic under certain other conditions. For example, in various embodiments, the ionic group or potentially ionic group may comprise a carboxylic acid group; a carboxylate group; a sulfonic acid group; a sulfonate group; a phosphonic acid group; a phosphonate group; or combinations of any thereof. In this regard, for example, carboxylic acid groups, sulfonic acid groups, and phosphonic acid groups are potentially ionic groups, whereas, carboxylate groups, sulfonate groups, and phosphonate groups are ionic groups in the form of a salt, such as, for example, a sodium salt.

For example, carboxylate (carboxylic acid) groups, sulfonate (sulfonic acid) groups, or phosphonate (phosphonic acid) groups may be covalently introduced into polyisocyanates to form hydrophilically-modified water-dispersible polyisocyanates. The ionic or potentially ionic groups may be introduced through a reaction between the isocyanate groups of the polyisocyanate and less than stoichiometric amounts of amino-functional or hydroxy-functional carboxylic acids, sulfonic acids, phosphonic acids, or salts thereof. Examples include, but are not limited to dimethylolpropionic acid (DMPA), N-(2-aminoethyl)-2-aminoethane sulfonic acid (AAS); N-(2-aminoethyl)-2-aminopropionic acid; 2-(cyclohexyl-amino)-ethane sulfonic acid; 3-(cyclohexyl-amino)-1-propane sulfonic acid (CAPS); 2-aminoethylphosphonic acid; or the salts thereof.

If free carboxylic acids, sulfonic acids, or phosphonic acids are incorporated in the polyisocyanate, then the acids may be neutralized with a neutralizing agent, such as, for example, tertiary amines, including, but not limited to, trialkyl-substituted tertiary amines. The preparation of hydrophilically-modified water-dispersible polyisocyanates is described, for example, in U.S. Pat. No. 6,767,958. Water-dispersible polyisocyanate mixtures based on triisocyanatononane (TIN) are described in International Patent Application Publication No. WO01/62819.

The NCO content of nonionic type hydrophilically-modified water-dispersible polyisocyanates may be from 5 to 25 weight percent of the polyisocyanate molecule. The NCO content of ionic type hydrophilically-modified water-dispersible polyisocyanates may be from 4 to 26 weight percent of the polyisocyanate molecule.

In addition to a polyisocyanate, the polyisocyanate composition can optionally include a variety of additional components. For example, as described above, organic tin compounds, or other suitable catalysts/accelerants, can accelerate the development of physical properties resulting from the reaction of a polyaspartate and a polyisocyanate. Thus, in some examples, where an organic tin compound, or other suitable catalyst/accelerant, is employed, the organic tin compound, or other suitable catalyst/accelerant, can be included in the polyisocyanate composition instead of or in addition to the polyaspartic composition. Where the organic tin compound, or other suitable catalyst/accelerant, is included in the polyisocyanate composition, it can generally be included in an amount of from about 0.1 wt % to about 1 wt % based on a total weight of the polyisocyanate composition. In other examples, the organic tin compound, or other suitable catalyst/accelerant, can be included in the polyisocyanate composition in an amount of from about 0.1 wt % to about 0.3 wt %, from about 0.2 wt % to about 0.4 wt %, or from about 0.3 wt % to about 0.5 wt % based on a total weight of the polyisocyanate composition. The same types of organic tin compounds and other suitable catalysts/accelerants as described with reference to the polyaspartic compositions can also be employed here.

A variety of additives can also be included in the polyisocyanate composition. Non-limiting examples of additives can include a filler, a pigment, a catalyst, a softener, a high-boiling liquid, a UV stabilizer, an anti-oxidant, a microbiocide, an algicide, a dehydrator, a thixotropic agent, a wetting agent, a flow enhancer, a matting agent, an anti-slip agent, an aerator, an extender, the like, or combinations thereof. Additives can be included in the polyisocyanate composition in an amount of from about 0.1 wt % to about 20 wt % based on a total weight of the polyisocyanate composition. In some specific examples, one or more additives can be individually or collectively included in the polyisocyanate composition in an amount of from about 0.1 wt % to about 4 wt %, 1 wt % to about 6 wt %, 4 wt % to about 10 wt %, about 5 wt % to about 15 wt %, or about 10 wt % to about 20 wt % based on a total weight of the polyisocyanate composition.

The polyisocyanate composition can generally have from about 70 wt % to about 100 wt % solids based on a total weight of the polyisocyanate composition, depending on the particular application. In some specific examples, the polyisocyanate composition can include from about 70 wt % to about 90 wt % or from about 80 wt % to about 100 wt % solids based on a total weight of the polyisocyanate composition.

To prepare the two-component polyurea compositions according to the invention, the polyisocyanate composition and polyaspartic composition and optional additives may be mixed with water in any order. In some embodiments, the polyaspartic composition can be mixed with any desired additives and then with the polyisocyanate composition. The resulting mixture is dispersed in water in a known manner with simple mixing. However, it is also possible to introduce one of the reactive components, such as the polyaspartic composition, with water and then introduce the polyisocyanate.

The polyisocyanate and polyaspartate composition are mixed in amounts which correspond to a minimum equivalent ratio of isocyanate groups to amino groups in some embodiments of 0.9:1, or 1.7:1, or 4:1, and a maximum equivalent ratio of 20:1, or 12:1, for example. In some specific examples, the polyisocyanate and the polyaspartate can be combined at an equivalent ratio of polyisocyanate equivalents to polyaspartate equivalents of from 1:1 to 1:3, or from 1.1 to 1.2. If polyurea compositions are desired that have better chemical resistance then higher NCO:NH equivalent ratios can be used. The flexibility/hardness of the polyurea composition may be further modified, e.g., by the selection of the diamine used to prepare the polyaspartic composition.

The polyurea compositions can be prepared at a variety of temperatures. In some specific examples, the polyurea compositions can be prepared at a temperature of less than 4° C. In some additional examples, the polyurea compositions can be prepared at a temperature of less than 0° C.

As mentioned herein, the inventive polyaspartic compositions may be combined with a polyisocyanate to produce polyurea compositions. The inventive polyurea compositions may be applied to a substrate in the form of a coating composition by conventional methods such as painting, rolling, pouring or spraying. Suitable substrates include, but are not limited to, metals, plastics, wood, cement, concrete and glass. The substrates to be coated by the polyurea coating composition according to the invention may be treated with suitable primers.

The inventive coating, adhesive, sealant, composite, casting, and film compositions may optionally contain additives such as fillers, pigments, softeners, high-boiling liquids, catalysts (such as organotin catalysts), UV stabilizers, anti-oxidants, microbiocides, algicides, dehydrators, thixotropic agents, wetting agents, flow enhancers, matting agents, anti-slip agents, aerators, and extenders.

Although the present invention is described and exemplified in the instant Specification in the context of a polyurea coating composition, the invention is not intended to be so limited. The principles of the invention are equally applicable to polyurethane, polyurea, polyurethane/urea coatings, adhesives, sealants, composites, castings, and films.

### Examples

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated.

| | |
|---|---|
| ASPARTATE A | a 100% solids content aspartic ester |
| | functional amine, having an amine number |
| | of approx. 190 mg KOH/g, |
| | viscosity @ 25° C. of about |
| | 1200-1600 mPa · s; |
| ASPARTATE B | a 100% solids content aspartic ester |
| | functional amine, having an amine |
| | number of approx. 244 mg KOH/g, |
| | viscosity @ 25° C. of about |
| | 90 mPa · s; |
| ISOCYANATE A | an aliphatic polyisocyanate resin based on |
| | hexamethylene diisocyanate, NCO content 23.5 ± |
| | 0.5%, viscosity 730 ± 100 mPa · s @ 23° C., |
| | commercially available from Covestro as |
| | DESMODUR N-3900; |
| ISOCYANATE B | a polyfunctional aliphatic isocyanate |
| | resin based on hexamethylene diisocyanate |
| | (HDI) having an NCO content of 19.5 ± 0.5% |
| | and a viscosity of 450 ± 150 |
| | mPa · s @ 25° C., |
| | commercially available from |
| | Covestro as DESMODUR XP- 2580; |
| C₂ to C₁₂ DIOL A | 1,4-butanediol (a C₂ to |
| | C₁₂ diol), |
| | commercially available from DuPont Co.; |
| C₂ to C₁₂ DIOL B | propylene glycol, commercially available |
| | from Fisher Scientific; |
| CATALYST | dibutyltin dilaurate, commercially available |
| | from Air Products; |

An example coating formulation (FORMULATION A) was made by combining the following ingredients in the amounts provided in Table I below:

TABLE I

| Polyaspartic Composition | | Polyisocyanate Composition | |
|---|---|---|---|
| | Amount | | Amount |
| Ingredient | (g) | Ingredient | (g) |
| POLYASPARTATE A | 56.86 | ISOCYANATE A | 38.14 |
| C₂ to C₁₂ DIOL A | variable | | |
| | | Mix Ratio (vol) | 1.78:1 |
| | | NCO:OH | 0.7 |
| | | P/B | 0 |
| | | PVC | 0 |
| | | Theoretical VOC | 0 |
| | | Volume Solids | 45.08 |
| | | Weight Solids | 59.55 |
| | | Wt/Gal | 11.55 |

Table II summarizes the results of reactivity testing of FORMULATION A with and without C₂ to C₁₂ DIOL A. As can be appreciated by reference to Table II, samples of FORMULATION A including 3% C₂ to C₁₂ DIOL (Sample II-B) and 5% C₂ to C₁₂ DIOL (Sample II-C) cured much faster than Sample II-A (containing no C₂ to C₁₂ DIOL A).

TABLE II

| | II-A | II-B | II-C |
|---|---|---|---|
| C₂ to | None | 3% | 5% |
| C₁₂ DIOL A | | | |
| Dry times (hours) | | | |
| STT (set-to-touch) | 7 | 3 | 3 |
| SD (surface dry) | 12 | 6 | 6 |
| HD (hard dry) | 14 | 7 | 7 |
| MF (mar free) | 18 | 10 | 10 |
| Temperature (° C.) | 21 | 21 | 21 |
| Relative Humidity (%) | 50 | 50 | 50 |
| Meter Used | 24 hour | 24 hour | 24 hour |

Table III summarizes the reduction in gel times observed with and without C₂ to C₁₂ DIOL A. As can be appreciated by reference to Table III, samples of ASPARTATE A reacted with ISOCYANATE A in the presence of 3% and 5% C₂ to C₁₂ DIOL A had dramatically shorter gel times than a control sample (no C₂ to C₁₂ DIOL A) and a sample containing only water (no C₂ to C₁₂ DIOL A).

TABLE III

| | | Water added to | | |
|---|---|---|---|---|
| | | ASPARTATE A | 3% C₂ to C₁₂ | 5% C₂ to C₁₂ |
| | No C₂ to C₁₂ | no C₂ to C₁₂ | DIOL A | DIOL A |
| | DIOL A | DIOL A | (+5% water) | (+5% water) |
| Gel time (minutes) | 545 | 452 | 38 | 45 |
| NCO/NH | 1.1 | 1.1 | 0.82 | 0.7 |

C₂ to C₁₂ DIOL A was also combined with a different aspartate to determine if similar improvements in rate of reaction and the development of ultimate physical properties might be observed. Table IV summarizes the effect of C₂ to C₁₂ DIOL A on reactivity rate and Shore D hardness. As can be appreciated by reference to Table IV, samples including 2% C₂ to C₁₂ DIOL A showed a shorter gel time than the combination of ASPARTATE B+ISOCYANATE A with no C₂ to C₁₂ diol. Additionally, Shore D hardness values remained relatively stable as compared to the initial data taken at the 1-hour time point, indicating that the ultimate physical properties also developed quite quickly. Shore D hardness was determined according to ASTM D2240.

TABLE IV

| | IV-A (wt.) | IV-B (wt.) | IV-C (wt.) |
|---|---|---|---|
| ASPARTATE B, 2% C₂ to | 50 | 50 | |
| C₁₂ DIOL A | | | |
| ASPARTATE B, no C₂ to | | | 50 |
| C₁₂ DIOL A | | | |
| ISOCYANATE A | less | more | 40 |
| NCO/NH | 1.1/1.0 | 1.3/1.0 | 1.1/1.0 |
| Gel time (seconds) | 20 | 30 | 75 |
| Shore D hardness | | | |
| 1 hour | 70 | 50 | |
| 5 hours | 70 | 50-55 | |
| 1 day | 70 | 60 | |
| 3 days | 72 | 65 | |

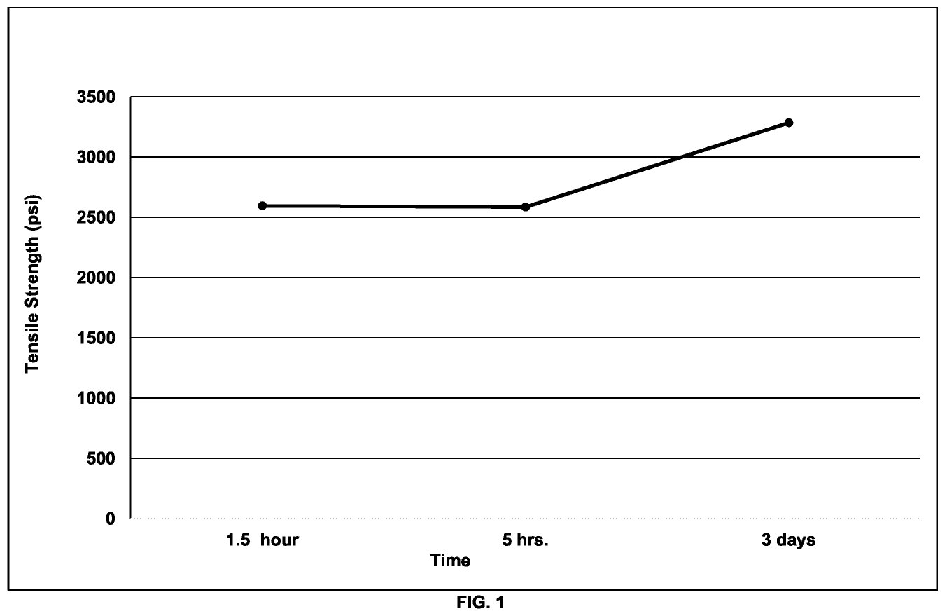

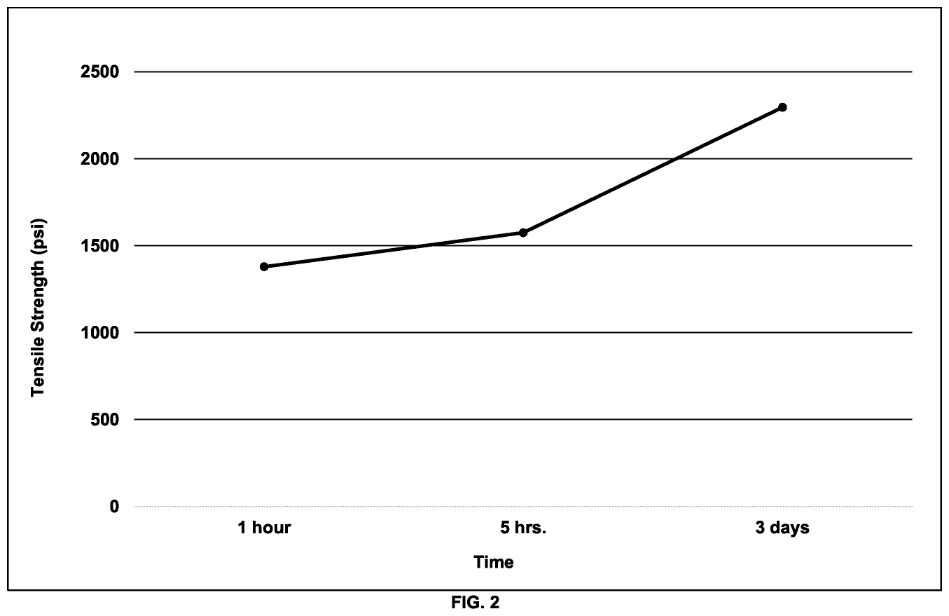

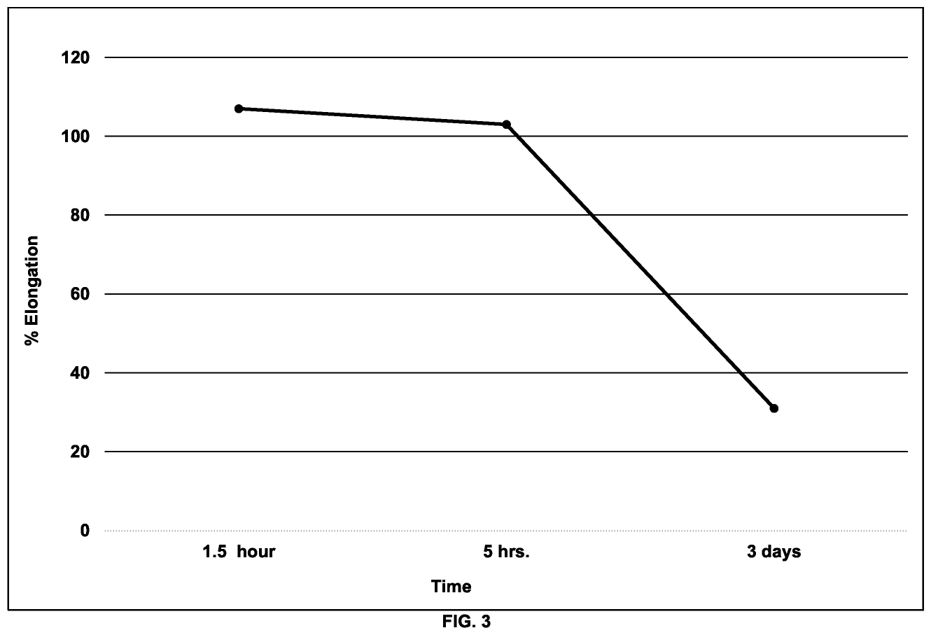

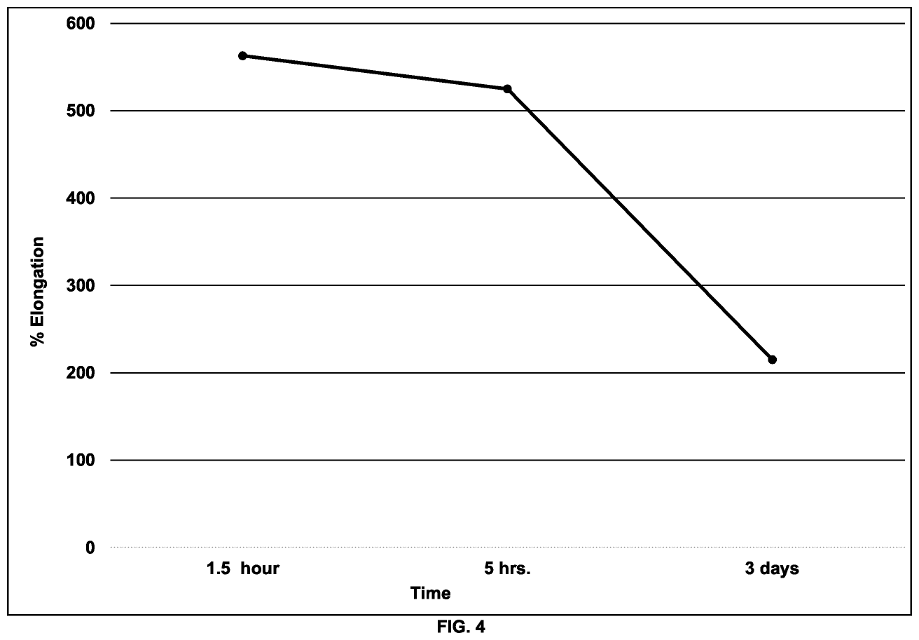

FIG. 1 is a plot of tensile strength (psi) of sample IV-A (less isocyanate) versus time over three days. FIG. 2 is a plot of tensile strength in psi of sample IV-B (more isocyanate) versus time over three days. FIG. 3 illustrates elongation percent of sample IV-A (less isocyanate) versus time over three days; and FIG. 4 depicts elongation percent of sample IV-B (more isocyanate) versus time over three days.

Table V summarizes the effect of using a higher percentage of C₂ to C₁₂ DIOL on reactivity, Shore D hardness, percent elongation (according to ASTM D412) and tensile strength (according to ASTM D638) for ASPARTATE B reacted with ISOCYANATE A or a mixture of ISOCYANATE A and ISOCYANATE B. As can be appreciated by reference to Table V, increasing the amount of C₂ to C₁₂ DIOL A or C₂ to C₁₂ DIOL B reduced gel time while the physical properties remained unaffected. Adding ethanol (4%) to C₂ to C₁₂ DIOL A slightly reduced the gel time (data not shown).

TABLE V

| | C₂ to | | | | | Tensile | % |
|---|---|---|---|---|---|---|---|
| | C₁₂ | | Gel | Shore | Shore | strength | Elon- |
| | DIOL | ISO- | time | D | D | (psi) | gation |
| Example | (10%) | CYANATE | (s) | 1 hr. | 24 hr. | 24 hr. | 24 hr. |
| V-A | A | A | 11 | 50 | 50 | 1837 | 339 |
| V-B | A | A/C 1:1 | 14 | 45 | 40 | 1658 | 349 |
| V-C | B | A/C 1:1 | 13 | 45 | 40 | 1472 | 395 |

Table VI summarizes the hardness and tensile/elongation development over time with and without an additional tin catalyst. As can be appreciated by reference to Table VI, it is surprising that the gel times are both very fast (similar) but the hardness is much lower initially without tin catalyst.

TABLE VI

| | without | | With | |
|---|---|---|---|---|
| Ingredient | CATALYST | % | CATALYST | % |
| ASPARTATE A | 100 | 45.25 | 100 | 45.21 |
| C₂ to C₁₂ DIOL A | 6 | 2.71 | 6 | 2.71 |
| CATALYST | 0 | 0.0 | 0.2 | 0.09 |
| ISOCYANATE A | 115 | 52.04 | 115 | 51.99 |
| total | 221 | | 221.2 | |
| NCO/NH + OH | 1.1 | | 1.1 | |
| mix ratio (volume) | 1 to 1 | | 1 to 1 | |
| Gel time (seconds) | 15 | | 15 | |
| Shore D (1 hour) | 30 | | 70 | |
| Shore D (24 hours) | 30 | | 70 | |
| Shore D (6 days) | 63 | | 72 | |
| Shore D (14 days) | 72 | | 72 | |
| Tensile Strength (psi) 1 day | 669 | | 2422 | |
| % Elongation (1 day) | 510 | | 46 | |
| Tensile Strength (psi) 6 days | 2880 | | 7561 | |
| % Elongation (6 days) | 34 | | 13 | |
| Tensile Strength (psi) 14 days | 8659 | | 8656 | |
| % Elongation (14 days) | 13 | | 13 | |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. A polyaspartic composition comprising a polyaspartate comprising a reaction product of a polyamine and a diester at a 1:1 stoichiometric ratio; and a C₂ to C₁₂ diol present in the polyaspartic composition in an amount of from about 1 wt % to about 10 wt % based on a total weight of the polyaspartic composition.

Clause 2. The polyaspartic composition according to Clause 1, wherein the diester comprises dimethyl maleate, diethyl maleate, dibutyl maleate, dimethyl fumarate, diethyl fumarate, dibutyl fumarate, or a combination thereof.

Clause 3. The polyaspartic composition according to one of Clauses 1 and 2, wherein the polyamine comprises ethylenediamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotoluylenediamine, 2,4′- and/or 4,4′-diaminodicyclohexylmethane, 3,3′-dimethyl-4,4′-diaminodicyclohexylmethane, 2,4,4′-triamino-5-methyldicyclohexylmethane, or a combination thereof.

Clause 4. The polyaspartic composition according to any one of Clauses 1 to 3, wherein the polyaspartate comprises a polyaspartate corresponding to formula (I):

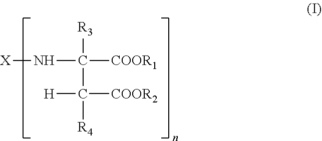

wherein:

n is an integer of at least 2;

X represents an aliphatic residue;

R₁ and R₂ independently represent organic groups that are inert to isocyanate groups under reaction conditions to generate the reaction product; and

R₃ and R₄ independently of each other represent hydrogen or organic groups that are inert to isocyanate groups under reaction conditions.

Clause 5. The polyaspartic composition according to any one of Clauses 1 to 4, wherein the C₂ to C₁₂ diol comprises ethylene glycol, 1,2-propanediol, 1,3-propanediol, 1,2-butanediol, 1,3-butanediol, 1,4-butanediol, 1,2-hexanediol, 1,5-hexanediol, 2,5-hexanediol, 1,6-hexanediol, 1,8-octanediol, 1,10-decanediol, 1,12-dodecanediol, diethylene glycol, triethylene glycol, diproplylene glycol, triproplylene glycol, or a combination thereof.

Clause 6. The polyaspartic composition according to any one of Clauses 1 to 5, wherein the catalyst comprises a C₂ to C₆ diol.

Clause 7. The polyaspartic composition according to any one of Clauses 1 to 6, wherein the polyaspartic composition comprises less than or equal to 5 wt % water based on a total weight of the polyaspartic composition.

Clause 8. The polyaspartic composition according to any one of Clauses 1 to 7, wherein the catalyst further comprises an organic tin compound.

Clause 9. The polyaspartic composition according to Clause 8, wherein the organic tin compound is present in the polyaspartic composition in an amount of from 0.1 wt % to 1 wt % based on the total weight of the polyaspartic composition.

Clause 10. The polyaspartic composition according to Clause 8, wherein the organic tin compound comprises dimethyltin diacetate, diethyltin diacetate, dibutyltin diacetate, dioctyltin diacetate, dilauryltin diacetate, dibutyltin dilaurate, dibutyltin maleate, or a combination thereof.

Clause 11. The polyaspartic composition according to any one of Clauses 1 to 10, wherein the catalyst comprises a C₂ to C₆ diol in an amount of from 2 wt % to 4 wt % based on the total weight of the polyaspartic composition and an organic tin compound in an amount of from 0.1 wt % to 0.3 wt % based on the total weight of the polyaspartic composition.

Clause 12. The polyaspartic composition according to any one of Clauses 1 to 11, wherein the polyaspartic composition has a viscosity of from 100 cP to 5000 cP.

Clause 13. The polyaspartic composition according to any one of Clauses 1 to 12, further comprising an additive in an amount of from 0.1 wt % to 50 wt % based on a total weight of the polyaspartic composition.

Clause 14. The polyaspartic composition according to any one of Clauses 1 to 13, wherein the additive comprises a filler, a pigment, a catalyst, a softener, a high-boiling liquid, a UV stabilizer, an anti-oxidant, a microbiocide, an algicide, a dehydrator, a thixotropic agent, a wetting agent, a flow enhancer, a matting agent, an anti-slip agent, an aerator, an extender, or a combination thereof.

Clause 15. A coating system, comprising the polyaspartic composition according to any one of Clauses 1 to 14; and a polyisocyanate composition, wherein the polyaspartic composition and the polyisocyanate composition are contained in separate containers.

Clause 16. The coating system according to Clause 15, wherein the polyisocyanate composition comprises ethylene diisocyanate, 1,4-tetramethylene diisocyanate, 1,6-hexamethylene diisocyanate, 2,2,4-trimethyl-1,6-hexamethylene diisocyanate, 1,12-dodecamethylene diisocyanate, 1-isocyanato-3-isocyanatomethyl-3,5,5-trimethyl-cyclohexane, bis-(4-isocyanatocyclohexyl)methane, cyclohexane 1,4-diisocyanate, bis-(4-isocyanato-3-methyl-cyclohexyl)methane, pentane diisocyanate, benzene diisocyanate, toluene diisocyanate, diphenylmethane diisocyanate, 4-isocyanatomethyl-1,8-octane diisocyanate, isomers of any thereof, or a combination of any thereof.

Clause 17. The coating system according to one of Clauses 15 and 16, wherein the polyisocyanate composition further comprises an organic tin compound.

Clause 18. The coating system according to Clause 17, wherein the organic tin compound is present in the polyisocyanate composition in an amount of from 0.1 wt % to 1 wt % based on the total weight of the polyisocyanate composition.

Clause 19. The coating system according to Clause 17, wherein the organic tin compound comprises dimethyltin diacetate, diethyltin diacetate, dibutyltin diacetate, dioctyltin diacetate, dilauryltin diacetate, dibutyltin dilaurate, dibutyltin maleate, or a combination thereof.

Clause 20. The coating system according to any one of Clauses 15 to 19, wherein the polyisocyanate composition further comprises an additive in an amount of from 0.1 wt % to 50 wt % based on a total weight of the polyisocyanate composition.

Clause 21. The coating system according to Clause 20, wherein the additive comprises a filler, a pigment, a catalyst, a softener, a high-boiling liquid, a UV stabilizer, an anti-oxidant, a microbiocide, an algicide, a dehydrator, a thixotropic agent, a wetting agent, a flow enhancer, a matting agent, an anti-slip agent, an aerator, an extender, and combinations thereof.

Clause 22. A polyurea composition comprising a reaction product of the polyaspartic composition according to any one of Clauses 1 to 14 and a polyisocyanate composition comprising a polyisocyanate, wherein the polyaspartate and the polyisocyanate are combined at an equivalent ratio of polyaspartate equivalents to polyisocyanate equivalents of from 1:1 to 1:3.

Clause 23. The polyurea composition according to Clause 22, wherein the polyisocyanate comprises ethylene diisocyanate, 1,4-tetramethylene diisocyanate, 1,6-hexamethylene diisocyanate (HDI), 2,2,4-trimethyl-1,6-hexamethylene diisocyanate, 1,12-dodecamethylene diisocyanate, 1-isocyanato-3-isocyanatomethyl-3,5,5-trimethyl-cyclohexane (isophorone diisocyanate or IPDI), bis-(4-isocyanatocyclohexyl)methane (H₁₂MD), cyclohexane 1,4-diisocyanate, bis-(4-isocyanato-3-methyl-cyclohexyl)methane, PDI (pentane diisocyanate-bio-based), benzene diisocyanate, toluene diisocyanate (TDI), diphenylmethane diisocyanate (MDI), 4-isocyanatomethyl-1,8-octane diisocyanate (triisocyanatononane or TIN), isomers of any thereof, and combinations of any thereof.

Clause 24. The polyurea composition according to one of Clauses 22 and 23, wherein the polyisocyanate composition further comprises an organic tin compound.

Clause 25. The polyurea composition according to Clause 24, wherein the organic tin compound is present in the polyisocyanate composition in an amount of from 0.1 wt % to 1 wt % based on the total weight of the polyisocyanate composition.

Clause 26. The polyurea composition according to Clause 24, wherein the organic tin compound comprises dimethyltin diacetate, diethyltin diacetate, dibutyltin diacetate, dioctyltin diacetate, dilauryltin diacetate, dibutyltin dilaurate, dibutyltin maleate, or a combination thereof.

Clause 27. The polyurea composition according to any one of Clauses 22 to 26, wherein the polyisocyanate composition further comprises an additive in an amount of from 0.1 wt % to 50 wt % based on a total weight of the polyisocyanate composition.

Clause 28. The polyurea composition according to Clause 27, wherein the additive comprises a filler, a pigment, a catalyst, a softener, a high-boiling liquid, a UV stabilizer, an anti-oxidant, a microbiocide, an algicide, a dehydrator, a thixotropic agent, a wetting agent, a flow enhancer, a matting agent, an anti-slip agent, an aerator, an extender, or a combination thereof.

Clause 29. One of a coating composition, an adhesive composition, a sealant composition, a composite composition, a casting composition, and a film composition comprising the polyurea composition according to any one of Clauses 22 to 28.

Clause 30. A coating composition comprising the polyurea composition according to any one of Clauses 22 to 28.

Clause 31. The coating composition according to Clause 30, further including an additive selected from the group consisting of fillers, pigments, softeners, high-boiling liquids, catalysts, UV stabilizers, anti-oxidants, microbiocides, algicides, dehydrators, thixotropic agents, wetting agents, flow enhancers, matting agents, anti-slip agents, aerators, extenders, and combinations thereof.

Clause 32. A substrate having applied thereto the coating composition according to one of Clauses 30 to 31.

Clause 33. The substrate according to Clause 32, wherein the substrate is selected from the group consisting of metal, plastic, wood, cement, concrete, and glass.

Clause 34. A method of making a polyurea composition comprising combining the polyaspartic composition of any one of Clauses 1 to 14 and a polyisocyanate composition comprising a polyisocyanate, wherein the polyaspartate and the polyisocyanate are mixed at an equivalent ratio of polyaspartate equivalents to polyisocyanate equivalents of from 1:1.1 to 1:2.

Clause 35. The method according to Clause 34, wherein the polyisocyanate composition comprises ethylene diisocyanate, 1,4-tetramethylene diisocyanate, 1,6-hexamethylene diisocyanate, 2,2,4-trimethyl-1,6-hexamethylene diisocyanate, 1,12-dodecamethylene diisocyanate, 1-isocyanato-3-isocyanatomethyl-3,5,5-trimethyl-cyclohexane, bis-(4-isocyanatocyclohexyl)methane, cyclohexane 1,4-diisocyanate, bis-(4-isocyanato-3-methyl-cyclohexyl)methane, pentane diisocyanate, benzene diisocyanate, toluene diisocyanate, diphenylmethane diisocyanate, 4-isocyanatomethyl-1,8-octane diisocyanate, isomers of any thereof, or a combination of any thereof.

Clause 36. The method according to one of Clauses 24 and 35, wherein the polyisocyanate composition further comprises an organic tin compound.

Clause 37. The method according to Clause 36, wherein the organic tin compound is present in the polyisocyanate composition in an amount of from 0.1 wt % to 1 wt % based on the total weight of the polyisocyanate composition.

Clause 38. The method according to Clause 36, wherein the organic tin compound comprises dimethyltin diacetate, diethyltin diacetate, dibutyltin diacetate, dioctyltin diacetate, dilauryltin diacetate, dibutyltin dilaurate, dibutyltin maleate, or a combination thereof.

Clause 39. The method according to any one of Clauses 34 to 38, wherein the polyisocyanate composition further comprises an additive in an amount of from 0.1 wt % to 50 wt % based on a total weight of the polyisocyanate composition.

Clause 40. The method according to Clause 39, wherein the additive comprises a filler, a pigment, a catalyst, a softener, a high-boiling liquid, a UV stabilizer, an anti-oxidant, a microbiocide, an algicide, a dehydrator, a thixotropic agent, a wetting agent, a flow enhancer, a matting agent, an anti-slip agent, an aerator, an extender, and combinations thereof.

Clause 41. One of a coating composition, an adhesive composition, a sealant composition, a composite composition, a casting composition, and a film composition comprising the polyurea composition made according to any one of Clauses 34 to 40.

Clause 42. A coating composition comprising the polyurea composition made according to any one of Clauses 34 to 40.

Clause 43. A substrate having applied thereto the coating composition made according to Clause 42.

Clause 44. The substrate according to Clause 43, wherein the substrate is selected from the group consisting of metal, plastic, wood, cement, concrete, and glass.

What is claimed is:

1. A polyaspartic composition comprising:
a polyaspartate comprising a reaction product of a polyamine and a diester at a 1:1 stoichiometric ratio; and
a C₂ to C₁₂ diol present in the polyaspartic composition in an amount of from 1 wt % to 10 wt % based on a total weight of the polyaspartic composition.

2. The polyaspartic composition according to claim 1, wherein the diester comprises dimethyl maleate, diethyl maleate, dibutyl maleate, dimethyl fumarate, diethyl fumarate, dibutyl fumarate, or a combination thereof.

3. The polyaspartic composition according to claim 1, wherein the polyamine comprises ethylenediamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotoluylenediamine, 2,4′- and/or 4,4′-diaminodicyclohexylmethane, 3,3′-dimethyl-4,4′-diaminodicyclohexylmethane, 2,4,4′-triamino-5-methyldicyclohexylmethane, or a combination thereof.

4. The polyaspartic composition according to claim 1, wherein the polyaspartate comprises a polyaspartate corresponding to formula (I): 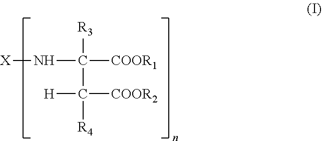
wherein:
n is an integer of at least 2;
X represents an aliphatic residue;
R₁ and R₂ independently represent organic groups that are inert to isocyanate groups under reaction conditions to generate the reaction product; and
R₃ and R₄ independently of each other represent hydrogen or organic groups that are inert to isocyanate groups under reaction conditions.

5. The polyaspartic composition according to claim 1, wherein the C₂ to C₁₂ diol comprises ethylene glycol, 1,2-propanediol, 1,3-propanediol, 1,2-butanediol, 1,3-butanediol, 1,4-butanediol, 1,2-hexanediol, 1,5-hexanediol, 2,5-hexanediol, 1,6-hexanediol, 1,8-octanediol, 1,10-decanediol, 1,12-dodecanediol, diethylene glycol, triethylene glycol, diproplylene glycol, triproplylene glycol, or a combination thereof.

6. The polyaspartic composition according to claim 1, wherein the C₂ to C₁₂ diol comprises a C₂ to C₆ diol.

7. The polyaspartic composition according to claim 1, wherein the polyaspartic composition comprises less than or equal to 5 wt % water based on a total weight of the polyaspartic composition.

8. The polyaspartic composition according to claim 1, further comprising an organic tin compound.

9. The polyaspartic composition according to claim 8, wherein the organic tin compound is present in the polyaspartic composition in an amount of from 0.1 wt % to 1 wt % based on the total weight of the polyaspartic composition.

10. The polyaspartic composition according to claim 8, wherein the organic tin compound comprises dimethyltin diacetate, diethyltin diacetate, dibutyltin diacetate, dioctyltin diacetate, dilauryltin diacetate, dibutyltin dilaurate, dibutyltin maleate, or a combination thereof.

11. The polyaspartic composition according to claim 1, wherein the C₂ to C₁₂ diol comprises a C₂ to C₆ diol in an amount of from 2 wt % to 4 wt % based on the total weight of the polyaspartic composition and the polyaspartic composition further comprises an organic tin compound in an amount of from 0.1 wt % to 0.3 wt % based on the total weight of the polyaspartic composition.

12. The polyaspartic composition according to claim 1, wherein the polyaspartic composition has a viscosity of from 100 cP to 5000 cP.

13. The polyaspartic composition according to claim 1, further comprising an additive in an amount of from 0.1 wt % to 20 wt % based on a total weight of the polyaspartic composition.

14. The polyaspartic composition according to claim 1, wherein the additive comprises a filler, a pigment, a catalyst, a softener, a high-boiling liquid, a UV stabilizer, an anti-oxidant, a microbiocide, an algicide, a dehydrator, a thixotropic agent, a wetting agent, a flow enhancer, a matting agent, an anti-slip agent, an aerator, an extender, or a combination thereof.

15. A polyurea composition, comprising a reaction product of the polyaspartic composition of claim 1 and a polyisocyanate composition comprising a polyisocyanate, wherein the polyaspartate and the polyisocyanate are combined at an equivalent ratio of polyaspartate equivalents to polyisocyanate equivalents of from 1:1 to 1:3.

16. The polyurea composition of claim 15, wherein the polyisocyanate comprises ethylene diisocyanate, 1,4-tetramethylene diisocyanate, 1,6-hexamethylene diisocyanate, 2,2,4-trimethyl-1,6-hexamethylene diisocyanate, 1,12-dodecamethylene diisocyanate, 1-isocyanato-3-isocyanatomethyl-3,5,5-trimethyl-cyclohexane, bis-(4-isocyanatocyclohexyl)methane, cyclohexane 1,4-diisocyanate, bis-(4-isocyanato-3-methyl-cyclohexyl)methane, pentane diisocyanate, benzene diisocyanate, toluene diisocyanate, diphenylmethane diisocyanate, 4-isocyanatomethyl-1,8-octane diisocyanate, isomers of any thereof, or a combination of any thereof.

17. One of a coating composition, an adhesive composition, a sealant composition, a composite composition, a casting composition, and a film composition comprising the polyurea composition of claim 15.

18. A coating composition comprising the polyurea composition of claim 15.

19. A substrate having applied thereto the coating composition of claim 18.

20. A method of making a polyurea composition comprising:
combining the polyaspartic composition of claim 1 with a polyisocyanate composition comprising a polyisocyanate, wherein the polyaspartate and the polyisocyanate are mixed at an equivalent ratio of polyaspartate equivalents to polyisocyanate equivalents of from 1:1 to 1:3.
